(19) United States
(12) Patent Application Publication
(10) Pub. No.: US 2004/0238526 A1
(43) Pub. Date: Dec. 2, 2004

(54) Made to the structure of a graphite resistance furnace

(76) Inventor: Andre Leycuras, Valbonne (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/482,090

(22) PCT Filed: Jun. 19, 2002
(86) PCT No.: PCT/FR02/02113

(30) Foreign Application Priority Data
Jun. 21, 2001 (FR) 01/08173

(51) Int. Cl. H05B 3/10

(52) U.S. Cl. 219/548; 219/541

(57) ABSTRACT

The invention relates to a high-temperature heater device (1) including at least one heater element (2), and current leads (20, 21) for powering the heater element(s) (2), said device being characterized in that it operates in any position, and in that each of the heater elements comprises at least one thin graphite strip (2) connected at its ends to the current leads by means of refractory conductive connection elements (3) made of molybdenum.

### GENERAL TECHNICAL FIELD

The invention relates to furnaces that offer high performance in terms of high temperature and long life.

More particularly, the invention relates to an improvement in the structure of furnaces having high-temperature resistances, in particular made of graphite.

### STATE OF THE ART

Generally, for applications requiring very high temperatures with high precision, e.g. for crystal growth applications for growing crystals of high purity, furnaces are used whose resistances are machined from blocks of graphite.

Such furnaces are consumable accessories. Their very high operating temperature gives rise to consumption of the graphite, either because of traces of oxygen in the atmospheres of the furnaces, even though their atmospheres are controlled, or because of the graphite subliming at those extreme temperatures.

Fine machining of the furnace resistance at the surface of the block of graphite makes it possible to obtain dimensional characteristics suitable for providing the desired temperature profile inside the furnace.

Such machining makes it possible to obtain the resistance desired for optimizing heat power as a function of the available electrical power supply.

A zigzag is cut out in the surface of the block along generator lines of the block, which is generally tube-shaped. The cutout allows the block to remain as rigid as possible.

Before it is machined, the block of graphite must be purified by being subjected to high temperature treatment. The larger the volume of the block, the longer the purification time.

Preferably, the graphite is then impregnated by diffusing carbon gas in order to reduce the porosity of the graphite. However, impregnation is possible to a limited depth only.

Unfortunately, the above techniques suffer from drawbacks.

Fine machining of the thickness profile of the surface is very difficult to achieve on a block.

For strength reasons, it is difficult to reduce the thickness of the block. Therefore, it is necessary to reduce the width of each resistive portion forming the zigzag and extending along generator lines of the block. The area of the surface radiating into the furnace is then reduced. It is then necessary to increase the temperature of the radiating surface to achieve the same working temperature for the furnace. The heater element thus evaporates more quickly, and the lifetime of the furnace is reduced.

Since the heater element is in a single block (or possibly in three blocks for a furnace powered by a three-phase power supply), then a single branch breaking makes the furnace completely unusable. In which case, a large amount of raw material (purified and treated graphite, which is expensive) is wasted, and so too is the entire cost of machining the block.

### SUMMARY OF THE INVENTION

The invention proposes to mitigate those drawbacks.

An object of the invention is to make such furnaces simpler to make and to economize the very costly material from which they are made.

In the invention, a material is used that can be obtained only for small-size pieces, for physical and economic reasons. However, the material must be capable of withstanding the extreme temperatures encountered in furnace applications.

The invention consists in connecting together heater pieces by conductive elements made of a material that is also a refractory material, and that also has other physical properties, and in particular satisfactory machinability, and resistivity suitable for obtaining maximum Joule effect.

To this end, the invention provides a device according to claim 1.

The invention is advantageously supplemented by the following characteristics, taken individually or in any technically feasible combination:

it includes at least one thin strip of purified and high-density graphite;

it includes at least one thin strip of purified and annealed iridium, tungsten, tantalum, or niobium;

at least one thin strip of purified and high-density graphite is covered with vitreous carbon;

it includes at least one thin strip of uniform thickness or of thickness whose profile is shaped;

it includes a conductive connection element made of niobium, or of tungsten, or of tantalum;

it includes a conductive connection element made of iridium, the thin strips then being made of iridium;

it includes a plurality of thin strips that are optionally of equal length, and that are connected together via their ends by means of conductive connection elements, at least two of said elements being suitable for being connected to the current leads;

the plurality of thin strips are assembled together by the connection elements to form a continuous zigzag suitable for forming a sheet in a plane or on any ruled surface;

the shape of the connection elements is suitable for imparting a cylindrical shape or a rectangular block shape to the sheet;

each connection element is suitable for co-operating with clamping and/or fixing means comprising bolts and/or nuts, and/or washers and/or plates which, at high temperatures, are thermo-chemically compatible with the materials of the strips and of the connection elements and with the atmosphere of the furnace, so that two elementary strips extend between said connection piece and said clamping or fixing means;

each graphite connection element is bonded to its strips by graphite adhesive bonding which is then purified and densified;

facing its connection elements, it includes a sheet of conductive material which, at high temperatures, is thermo-chemically compatible with the material of the thin strips, and with the material of the connection elements, and also with the atmosphere of the furnace, said sheet extending between the connection elements and the thin strips;

the connection elements are substantially upside-down T-shapes, the thin strips extending facing the horizontal portion of the upside-down T-shape, the vertical portion being provided with means suitable for serving as electrical connection means and as fixing means for fixing the resistance to an insulating support;

each of the upside-down T-shapes has a fold in its middle along its vertical axis, the two horizontal portions forming an angle relative to their position in which the connection element is not folded, which angle is equal to 360° divided by the number of thin strips extending in the resistance;

each of the two horizontal portions of the upside-down T-shape is beveled to form a substantially triangular shape whose vertices that extend along the vertical axis of the T-shape have a vertex angle equal to 360° divided by the number of thin strips extending in the resistance, the two bevels being offset radially on a plane normal to the plane of the upside down T-shape and facing their vertices by a step suitable for preventing electrical breakdown from occurring between two thin strips mounted on a connection element, and for obtaining an apparent radial overlap between two thin strips mounted on a connection element;

the connection elements are limited merely to the horizontal portion of the T-shape, and the connection elements are secured to their adjacent connection elements by electrically insulating plates; and

insulating pieces serve both to hold the connection pieces mutually in position, and also to hold heat screens at a suitable distance from one another and at a suitable distance from the thin strips.

The invention also provides a method of manufacturing a device according to claim 1.

### BRIEF DESCRIPTION OF THE FIGURES

Other characteristics and advantages of the invention appear from the following description which is given merely by way of non-limiting illustration, and which should be read with reference to the accompanying drawings, in which:

FIG. 1 is an overall view of a resistance in a preferred embodiment of the invention;

FIG. 2 is an overall view of a connection piece in an embodiment of the invention;

FIG. 3 is an overall view of a connection piece in a second embodiment of the invention;

FIG. 4 is an overall view of a connection piece in a third embodiment of the invention; and

FIG. 5 is an overall view of an embodiment of a piece making it possible to interconnect the connection pieces.

### DESCRIPTION OF A PREFERRED EMBODIMENT

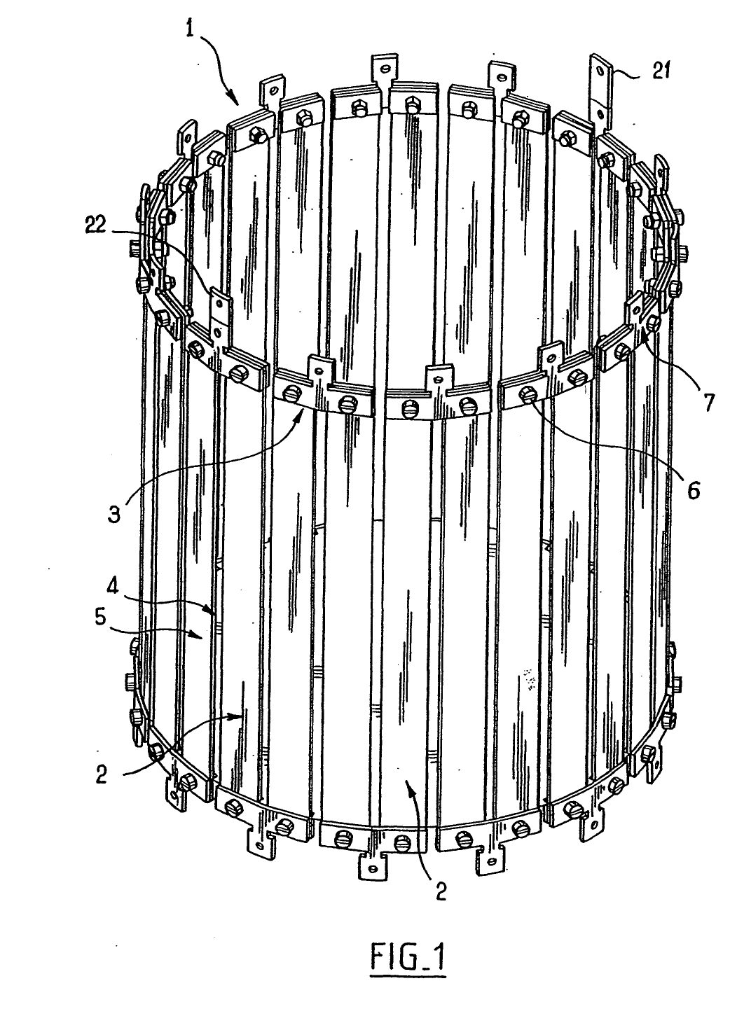

FIG. 1 shows a preferred embodiment of a resistance 1 of a graphite furnace. The electrical power supply considered in the description below is single-phase.

The resistance 1 comprises a strip or a plurality of elementary thin strips 2 of elongate shape and connected together in succession via their ends by means of connection pieces 3.

The strips 2 may be aligned lengthwise, the strips 2 then being disposed end-to-end.

The strips 2 may be of different lengths.

However, the embodiment shown in FIG. 1 shows that the succession of elementary strips 2 loops back on itself to extend in the form of a continuous zigzag.

The zigzag of elementary strips 2 is suitable for forming a sheet.

The sheet may be curved so as to form a substantially circularly symmetrical cylinder, the long directions of the strips 2 thus forming the generator lines of the circularly symmetrical cylinder.

The elementary strips 2 are connected together via conductive connection pieces 3.

The number N of strips 2 may be chosen at will to be one or more than one.

If N is small, the connection pieces 3 are substantially of circular arcuate shape of radius equal to the radius of the furnace. The strips 2 of graphite can be fine enough to be curved over a circularly symmetrical cylinder of quite small radius. The sheet can be curved over the length direction of the strips or over the width direction thereof, but it is preferably curved over the width direction of each strip 2.

A plurality of strips 2 are aligned and assembled together in the longitudinal direction when a structure of greater height or length is desired.

In order to fix the strips 2 together, connection pieces 3 can be used that are adapted to the desired geometrical shape, and that are made of molybdenum, for example.

The elementary strips 2 are preferably made of purified and densified graphite.

They can also be made of purified and annealed tungsten, tantalum, niobium, or molybdenum.

They can be cut to the desired width, determined so as to obtain a resistance value adapted to produce the desired heat power from the electrical power supply.

For example, the strips are cut using a diamond wire saw from a plate of graphite of shaped thickness profile. The shaped thickness profile of the plate is defined before it undergoes final treatment for covering it with vitreous carbon.

The profile along a longitudinal axis of the thickness of the plate of graphite from which the strips are cut out may be chosen such as to reinforce the power available at the ends of the furnace, and, if so desired, a more uniform profile may be chosen along the axis of the furnace, for example.

Advantageously, the graphite of the plate is treated to have:

maximum purity when that is necessary, e.g. in a crystal growth furnace;

minimum porosity to avoid degassing and/or appearance of hot spots which little by little end up interrupting the heater element.

The density of the graphite is increased by diffusing carbon as a gas.

Finally, the surface of the plate may be covered in a deposit of vitreous carbon in order to seal the surface and to increase its ability to withstand oxidation.

All of these treatments significantly increase the lifetime of the heater elements 2.

For example, the strips may be rectilinear in structure. Their oblong section is then rectangular. As shown in FIG. 1, the areas of the edges 4 of the elementary strips 2 are much smaller than the areas of the faces 5. However, the edges 4 of the strips 2 are subjected to the same atmosphere while the furnace is operating. It is possible either to ignore their influence, or advantageously to coat them with vitreous carbon in order to attenuate said influence. Also advantageously, the elementary strips 2 may be cut to the design dimensions before the entire strip 2 is covered with vitreous carbon, thereby protecting the edges 4.

Since the diamond cutting wire preferably has a small diameter of 0.15 millimeters (mm), the loss of material is extremely small. Problems of breakage or of removal of chippings are thus avoided.

The fine adjustment of the width of the strips 2 and the finishing (de-burring) of each strip 2 can then be performed by abrasion with abrasive paper.

For example, for a cylindrical furnace that is to have constant temperature on each right section, all of the strips 2 have the same width.

In contrast, the strips 2 have different widths for obtaining a different geometrical shape in which it is desired for the edge effect to be compensated by delivering additional heat power to specific locations.

FIG. 1 shows a furnace structure having twenty-eight elementary graphite heater strips 2.

The elementary strips 2 are mounted in two parallel paths, each of which is made up of fourteen heater strips. Each path occupies a 180° sector of a symmetrical cylinder. The two circularly symmetrical cylinder sectors face each other.

Extended connection pieces 21 and 22 that are diametrically opposite and on the same end of the circularly symmetrical cylinder serve to separate the paths and to provide connections to the current leads.

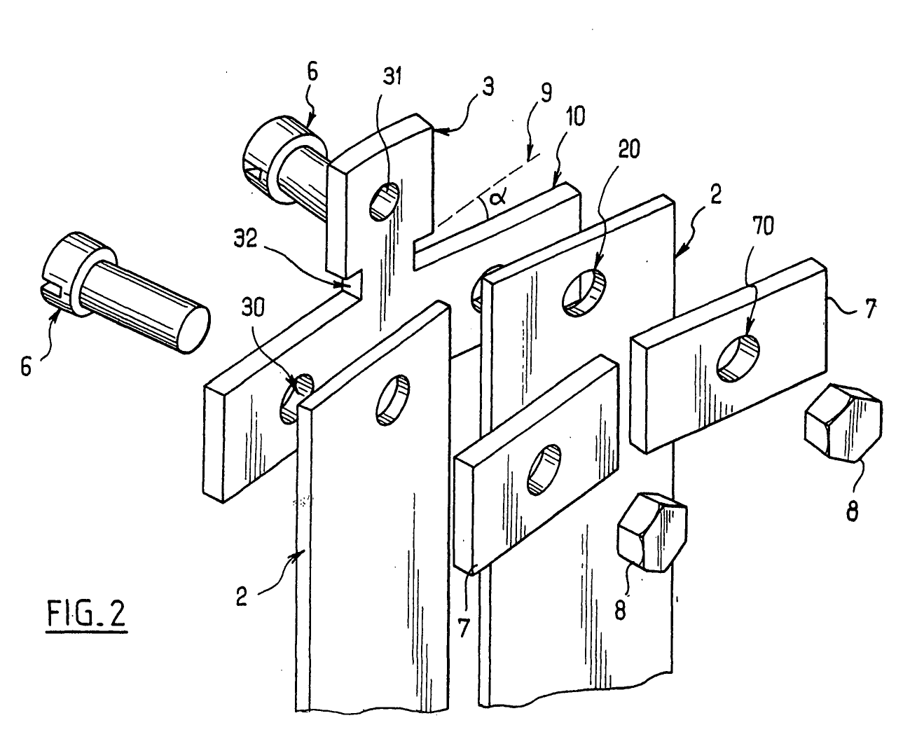

As shown in FIG. 2, each strip 2 can be provided with at least one hole 20 at each end in order to pass at least one fixing bolt 6.

Instead of being provide with holes, the strips 2 can be mounted so that they are clamped in the connection pieces 3.

The connection pieces 3 are preferably made of molybdenum.

There are several reasons for choosing this material:

it is refractory;

it is machinable;

it does not easily form a carbide;

it has a low vapor pressure; and

it has high chemical stability in environments and atmospheres compatible with graphite.

If the vapor pressure of molybdenum is too high for a particular application, the connection pieces may be made of graphite with inert and refractory insulating plates that insulate the graphite from the tungsten nuts and bolts that clamp the resulting assembly in order to avoid a reaction in which the tungsten is carburized.

The pieces 3 are plates, preferably provided with tapped holes 30 for fixing the graphite strips 2 in the proper positions.

During assembly, the strips 2 are not necessarily parallel because the risk of electrical breakdown is zero at the connection piece 3 but at a maximum at their other ends. The percentage of the emitting surface that is occupied can thus be greater than the occupied percentage obtained with conventional machining for a furnace made of a graphite block.

Depending on the shape of the connection pieces 3, it is possible to obtain all sorts of geometrical shapes using any surface that is ruled or otherwise, it being possible for the elementary strips 2 to be highly curved if they are thin.

It is also possible to implement a continuous apparent surface by accepting a small amount of visual overlap between the strips without contact between them.

All of the connection pieces 3 are identical optionally except for the connection pieces that are connected to the current leads 21 and 22.

They are all easily machinable in quantity and they are reusable.

The contact area between the graphite of an elementary strip 2 and a connection piece 3 on the hot side must be at least equal to the area of the section of the elementary strip 2 in its thickest portion, in order to avoid current density becoming too high locally. Since the electrical conductivity of molybdenum is about one hundred times higher than the electrical conductivity of graphite, generally the thickness of the connection pieces 3 needs mainly to satisfy constraints of strength and of ease of machining.

The contact surfaces between a connection piece 3 and an elementary strip 2 of graphite must be as plane and polished as possible, in order to prevent them from sticking at hot points. This makes it easier to change the elementary strips 2 during maintenance operations.

The elementary strips 2 are fixed to the connection pieces 2 by clamping bolts 6, washers (not shown in the figures) made of polished molybdenum then being situated between respective nuts 8 and the graphite of the elementary strips 2.

Advantageously, each washer is replaced by a plate 7 of molybdenum, that is preferably rectangular, polished and provided with a smooth hole 70 of the same size as the tapped holes 30 in the connection pieces 3. The plates 7 are identical for two elementary strips 2 of graphite united by a common connection piece 3.

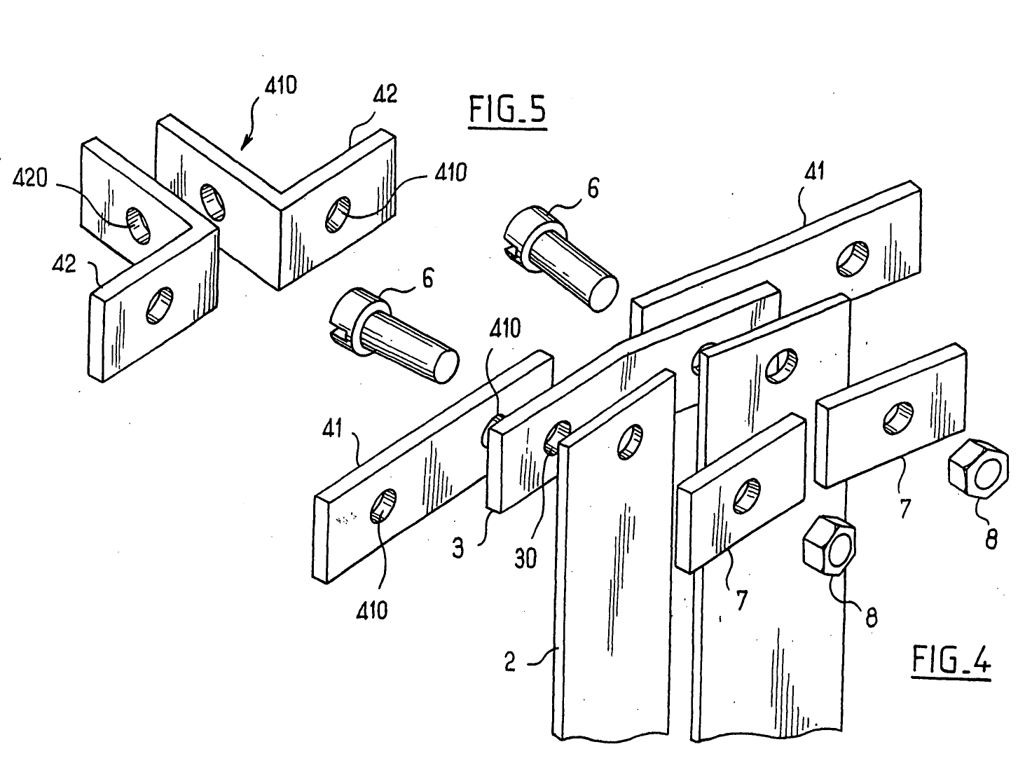

The connection pieces 3 may be extended towards the outside of the furnace, so that they are T-shapes. They are then adapted to be fixed to an electrical insulator which is chemically and thermally compatible with the environment of the furnace. For example, the insulating material may be alumina or boron nitride. For the highest temperatures and/or for dimensions larger than those of available materials, the connection pieces can be held together by plates 41 made of hafnium oxide (FIG. 4, described below), or of other compatible insulators, connecting a connection piece 3 to its adjacent piece and fixed by the same bolts as in FIG. 4. The vertical bar of the T-shape being formed integrally with the remainder of the connection piece also guarantees that the overall geometrical shape is maintained.

Heat screens (not shown in the figures) extending between the connection pieces 3 and the environment of the furnace may be fixed to the connection pieces via the insulating pieces 42 shown in FIG. 5, replacing the pieces 41. They are advantageously made of molybdenum, of tantalum, or of graphite foam. They make it possible to minimize energy losses by radiation. The energy consumption is thus reduced while increasing the lifetimes of the components of the furnace.

### FIRST POSSIBLE EMBODIMENT OF THE CONNECTION PIECES

A first possible mode of assembly of the elements facing the connection pieces 3 is described in more detail below.

As shown in FIG. 2, the connection piece 3 is made by folding an upside-down T-shaped piece machined from a flat sheet.

The central element of the T-shape is adapted to fix the device to a support, in particular an insulator. In particular, it may be fixed by means of the hole 31.

The horizontal portion of the upside-down T-shape is adapted to support two adjacent strips.

The piece 3 is preferably made of molybdenum.

The angle α between the plates 9 and 10 is shown in FIG. 2. It is equal to 360° divided by the number of elementary strips 2 that are disposed in the resistance 1.

For example, it is equal to zero if a single heater plate is desired.

In order to adapt the resistance of the furnace to match the power of the generator, it is possible to act on the choice of the material used for the strips for its resistivity, on the geometrical shape of the strips, and on whether the strips are assembled purely series or in series-parallel. Depending on the number of strips, the inlets and outlets 21 and 22 are on the same side or on opposite sides.

The elementary strips 2 are preferably made of graphite that is purified, densified, and covered with vitreous carbon.

The elementary strips 2 extend between the pieces 3 and 7, the bolts 6 passing through the non-tapped holes in the pieces 2, 3, and 7 clamping the resulting assembly by co-operating with the nuts 8.

The order of the pieces 3 and 7 may be reversed so as to clamp the elementary strips 2 onto the outside of the piece 3. It is thus possible to avoid the problem that might arise of the piece 3 having a radius of curvature that is too large facing the axis of the fold.

In the configuration shown in FIG. 2, this problem is avoided by spacing the strips 2 apart from the curved zone. However, the occupied percentage of the heater surface is reduced.

In a variant the pieces 7 may constitute respective single folded plates. Their holes may also be tapped. It is thus possible to omit the nuts 8.

A sheet of graphite paper may be interposed on either side of the elementary strips 2 facing the contacts with the connection pieces 3 in order to improve electrical contact. Subsequent disassembly of the elementary strips 2 during maintenance operations is also facilitated.

The sheet of paper may also be made of molybdenum.

The width of the horizontal bar of the upside-down T-shape is equal to the sum of the widths of the elementary strips 2, plus the gap between the elementary strips 2 that is necessary to avoid electrical discharges between said strips 2.

The vertical portion of the upside-down T-shape may be very long. It is suitable for fixing the positions of the elementary strips 2 in an insulating piece (not shown in the figure). A tapped hole 31 extending through the top portion of the vertical portion makes such fixing possible. A narrowed portion or neck 32 in the vertical bar makes it possible to reduce energy losses by heat conduction.

The faces of the pieces 3, 2, and 7 must be plane and polished in order to guarantee low contact resistance.

The thicknesses of the pieces 3 and 7 are not necessarily equal. They may even be very fine.

However, the thickness of the piece 3 must be sufficient to-perform its mechanical function of fixing the strips 2 without imparting a resistance that is too high.

### SECOND POSSIBLE EMBODIMENT OF THE CONNECTION PIECES

A second possible mode of assembly of the elements facing the connection pieces 3 is described below.

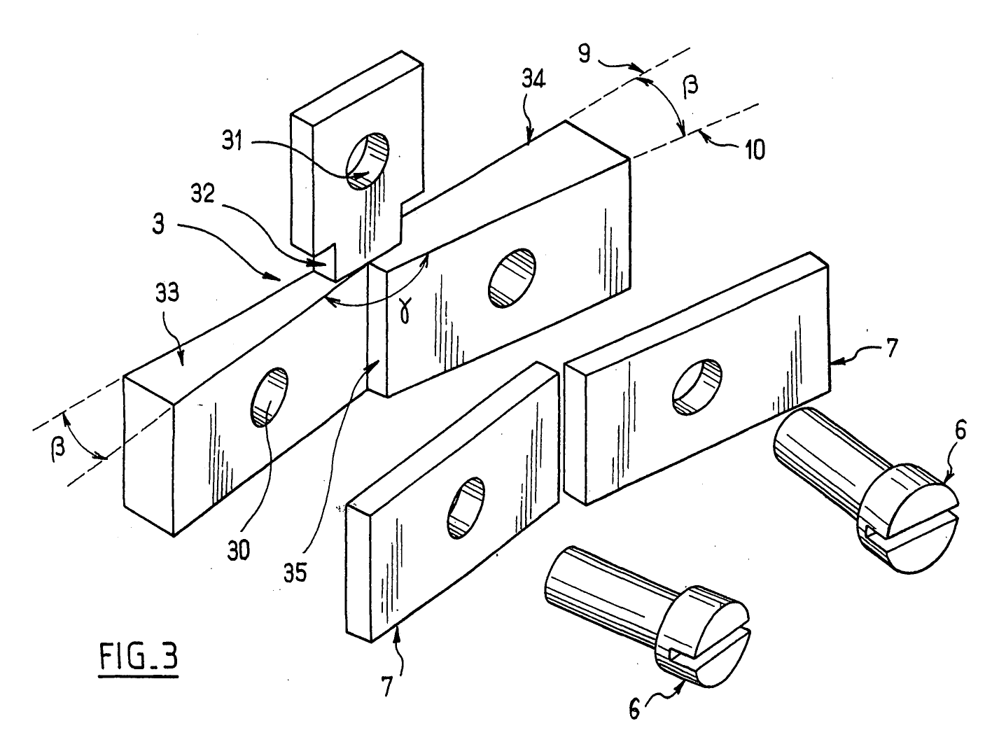

As shown in FIG. 3, the connection piece 3 is also substantially an upside-down T-shape.

In this embodiment too, the central portion of the T-shape is adapted to fix the connection pieces to a support, which may be an insulator, for example.

The horizontal portion externally supports two parallel adjacent strips. The horizontal portion comprises two portions defining joining wedges. The outside faces of the wedges are coplanar, their inside faces being neither coplanar nor parallel. The angle between the two inside faces of the wedges is referenced γ. The angle between the inside face and the outside face is referenced β. The angle β (angle at the vertices of the wedges) is equal to 360° divided by the number of thin strips 2 extending in the resistance.

A radial offset 35 is provided over the vertices of the wedges, in the central portion of the upside down T-shape. The strips (not shown in FIG. 3) are mounted on the inside face of the central portion. They are clamped between the plates 7 and the inside face of the central portion.

When the radial offset 35 is greater than the thickness of a strip, then it is possible for the strips to appear to overlap. Thus, 100% of the surface of the furnace is occupied with the heater surface. Such overlapping is very advantageous.

In all cases, the difference in thickness 35 at the vertex must be sufficient to prevent electrical discharge in the radial direction of the resistance 1 between two strips 2.

The connection piece 3 is made by being machined from solid molybdenum or from solid graphite. Solid pieces are advantageously used for large-size furnaces for use at very high temperatures.

Machining from solid material offers the possibility of making connection pieces 3 that are more elaborate than the pieces obtained by folding in the first embodiment.

### THIRD POSSIBLE EMBODIMENT OF THE CONNECTION PIECES

FIG. 4 shows a third possible embodiment of the connection pieces 3.

In this third embodiment, each connection piece 3 is limited to the horizontal portion of the connection piece 3 of the first embodiment shown in FIG. 2.

The resistance strips 2 are coupled together by the conductive piece 3. The pieces 2 and 3 are held in good electrical contact by the bolts 6 and by the nuts 8. Electrically insulating refractory plates 41 are interposed between the bolts 6 and the connection piece 3. Electrically insulating refractory plates 7 are interposed between the strips 2 and the nuts 8. The plates 41 and 7 have no thermo-chemical reactions either with the graphite or with the material of the bolts 6 or nuts 8 while the furnace is in operation.

The dimensions of the pieces 41, in particular their horizontal extent and the positions of the holes 410 are suitable for guaranteeing good spacing between adjacent and successive strips 2. Similarly, the dimensions of the connection pieces 3 are suitable for guaranteeing this good spacing.

Similarly, the horizontal extent of each connection piece 3 may be shortened. The insulating path along the pieces 41 between adjacent connection pieces 3 is thus increased. Short-circuits along the pieces 41 are thus avoided.

In order to simplify machining of the pieces 41, the angle at the vertices of the pieces 3 may be equal to 360° divided by the number of pairs of strips 2.

FIG. 5 shows that each of the plates 41 may also be made up of two adjoining angle brackets 42. This makes it easier to hold on heat screens (not shown in the figures), which screens surround the furnace. For example, they may be held by means of the holes 420.

Special connection pieces 3 (not shown in FIGS. 2 to 5) are extended to facilitate connection to the current leads. They are referenced 21 and 22 in FIG. 1.

In this embodiment, it is easy to form a volume that is heated over its entire outside surface by closing the ends of a heater cylinder (e.g. a circularly symmetrical cylinder) formed in accordance with the invention by heater sheets also formed in accordance with the invention.

The connection pieces are shown to be identical and symmetrical in order to simplify the description, but it is possible to give them the shapes necessary to adapt the shape of the heater sheet to any ruled surface of any outline.

When resistive strips 2 made of graphite and connection pieces 3 made of graphite are used, they may advantageously be assembled by adhesive bonding with a purified and densified graphite adhesive.

Naturally, the present invention is not limited to the above-described particular embodiments, but rather it extends to any variant that complies with the spirit of the invention.

### ADVANTAGES OF THE INVENTION

The precision obtained when machining the elementary heater strips 2 is much higher than the precision obtained by a single-block state-of-the-art furnace.

In addition, machining is greatly simplified compared with single-block machining in the state of the art. The risk of the pieces breaking during machining is much lower. Even if a piece does break during machining, the consequences in terms of wastage of material are much less serious.

With suitable connection pieces, it is easy to make furnaces having any heater surface shape, and to obtain high occupancy percentages. It is thus possible to obtain improved temperature uniformity for minimum heater element temperature. It is thus possible to obtain longer furnace life.

The graphite used for the strips may be of quality that is considerably higher than the quality of the graphite used in a single-block furnace. The higher quality of the graphite guarantees considerably longer life for the elementary strips 2 at equivalent working conditions.

The maximum temperature of the furnace is limited only by the thermo-chemical properties of the component material of the connection elements.

Furthermore, the connection pieces 3 can be re-used indefinitely.

Even after they have been subjected to temperatures as high as 2300° C., the connection elements 3 can be removed from the elementary strips 2. It is easy to change a single elementary graphite strip 2 of the furnace.

It will be understood that the furnace of the invention offers an economic advantage compared with conventional machining of an all-graphite furnace from a single block.

The occupancy percentage can reach very high levels. It is thus possible to reduce the power per unit area, and the lifetime of the furnace is extended, other things remaining equal.

A furnace of the invention may be used in any position because of the rigidity of graphite, which rigidity is even reinforced at high temperatures.

It is advantageously used in a horizontal position.

The example of graphite furnaces has been chosen to illustrate the advantages of the invention.

However, the invention applies to other materials, for other atmospheric conditions.

The thin heater strips may, for example, also be made of purified and annealed tungsten, tantalum, niobium, or molybdenum.

The only conditions for choosing the materials for the connection piece—for electrical and mechanical connection—and for the elementary strips are their thermo-chemical compatibility between one another and with the atmosphere in which they are immersed.

They must not create a eutectic having a melting point that is too low. It is also necessary to avoid recrystallization of the materials at high temperatures, because such recrystallization weakens them.

For example, it is possible to assemble connection pieces made of niobium, tungsten, tantalum, or graphite for furnaces having reducing or neutral atmospheres, or made of iridium with elementary strips of iridium for oxidizing atmospheres.

In the event that the graphite of the elementary strips 2 is incompatible with the conductive material of the connection piece 3, which conductive material otherwise has all of the required qualities, then a sheet of conductive material,—e.g. a metal—that is compatible may advantageously be interposed between the graphite and the incompatible conductive material of the connection piece.

The sheet is advantageously made of molybdenum.

It is advantageously possible to combine a connection element made of molybdenum, an interposed sheet advantageously made of molybdenum, a graphite strip, and another interposed sheet advantageously made of molybdenum so that the graphite strip is interposed between the two interposed sheets, the resulting assembly being held in place by a nut and a bolt that are made of molybdenum.

The connection piece may be made of the same material as the heater element—elementary strip 2.

The above description relates to a single-phase electrical power supply. The invention may also be used for two-phase or three-phase power supplies. In such particular power supply cases, it is possible to interleave the respective sectors corresponding to the various electrical phases, e.g. by interleaving and staggering the legs of the zigzags superposed in the height direction, so that heat distribution is as uniform as possible.

1. A high-temperature heater device (1) including at least one heater element (2), and current leads (20, 21) for powering the heater element(s) (2), said device being characterized in that it operates in any position, and in that each of the heater elements comprises at least one thin graphite strip (2) connected at its ends to the current leads by means of refractory conductive connection elements (3) made of molybdenum.

2. A device according to claim 1, characterized in that it includes at least one thin strip (2) of purified and high-density graphite.

3. A device according to any one of claims 1 to 2, characterized in that it includes at least one thin strip (2) of purified and annealed iridium, tungsten, tantalum, or niobium.

4. A device according to any one of claims 1 to 3, characterized in that at least one thin strip (2) of purified and high-density graphite is covered with vitreous carbon.

5. A device according to any one of claims 1 to 4, characterized in that it includes at least one thin strip (2) of uniform thickness or of thickness whose profile is shaped.

6. A device according to any one of claims 1 to 5, characterized in that it includes a conductive connection element (3) made of niobium, or of tungsten, or of tantalum.

7. A device according to any one of claims 1 to 5, characterized in that it includes a conductive connection element (3) made of iridium, the thin strips then being made of iridium.

8. A device according to any one of claims 1 to 7, characterized in that it includes a plurality of thin strips (2) that are optionally of equal length, and that are connected together via their ends by means of conductive connection elements (3), at least two of said elements (3) being suitable for being connected to the current leads (21, 22).

9. A device according to claim 8, characterized in that the plurality of thin strips (2) are assembled together by the connection elements (3) to form a continuous zigzag suitable for forming a sheet in a plane or on any ruled surface.

10. A device according to claim 9, characterized in that the shape of the connection elements (3) is suitable for imparting a cylindrical shape or a rectangular block shape to the sheet.

11. A device according to any one of claims 1 to 10, characterized in that each connection element (3) is suitable for co-operating with clamping and/or fixing means comprising bolts (6) and/or nuts (8), and/or washers and/or plates (7, 41) which, at high temperatures, are thermo-chemically compatible with the materials of the strips (2) and of the connection elements (3) and with the atmosphere of the furnace, so that two elementary strips (2) extend between said connection piece (3) and said clamping or fixing means.

12. A device according to any one of claims 1 to 11, characterized in that each graphite connection element (3) is bonded to its strips (2) by graphite adhesive bonding which is then purified and densified.

13. A device according to any one of claims 1 to 12, characterized in that, facing its connection elements (3), it includes a sheet of conductive material which, at high temperatures, is thermo-chemically compatible with the material of the thin strips (2), and with the material of the connection elements (3), and also with the atmosphere of the furnace, said sheet extending between the connection elements and the thin strips.

14. A device according to any one of claims 1 to 13, characterized in that the connection elements (3) are substantially upside-down T-shapes, the thin strips extending facing the horizontal portion of the upside-down T-shape, the vertical portion being provided with means (31) suitable for serving as electrical connection means and as fixing means for fixing the resistance to an insulating support.

15. A device according to any one of claims 1 to 14, characterized in that each of the upside-down T-shapes has a fold in its middle along its vertical axis, the two horizontal portions forming an angle relative to their position in which the connection element is not folded, which angle is equal to 360° divided by the number of thin strips (2) extending in the resistance.

16. A device according to any one of claims 1 to 14, characterized in that each of the two horizontal portions of the upside-down T-shape is beveled to form a substantially triangular shape whose vertices that extend along the vertical axis of the T-shape have a vertex angle equal to 360° divided by the number of thin strips (2) extending in the resistance (1), the two bevels being offset radially on a plane normal to the plane of the upside down T-shape and facing their vertices by a step (35) suitable for preventing electrical breakdown from occurring between two thin strips (2) mounted on a connection element (3), and for obtaining an apparent radial overlap between two thin strips (2) mounted on a connection element (3).

17. A device according to claim 15 or claim 16, characterized in that the connection elements (3) are limited merely to the horizontal portion of the T-shape, and in that the connection elements (3) are secured to their adjacent connection elements by electrically insulating plates (41).

18. A device according to claim 17, characterized in that insulating pieces (42) serve both to hold the connection pieces (3) mutually in position, and also to hold heat screens at a suitable distance from each other and at a suitable distance from the thin strips (2).

19. A method of manufacturing a resistance according to any one of claims 1 to 18, the method being characterized in that:
thin strips are cut out from a refractory material;
one or more thin strips are assembled together by aligning them end-to-end, this alignment being performed mechanically or by adhesive bonding, by means of one or more connection element(s) made of refractory conductive material which, at high temperatures, is thermo-chemically compatible with the refractory material of each thin strip, and with the atmosphere of the furnace.

20. A method according to claim 19, characterized in that the assembly of thin strips is looped back on itself in a continuous zigzag configuration to form a sheet in a plane or on any ruled surface.

21. A method according to claim 19 or claim 20, characterized in that the geometrical shape of the furnace is formed by imparting suitable shapes to the connection elements (3) forming the edges of the sheet.

22. A method according to any one of claims 19 to 21, characterized in that:
the thin strips are cut out by means of a diamond cutting wire having a small diameter of 0.15 mm; and
the material of the thin strips is densified by diffusing carbon gas.

23. A method according to any one of claims 19 to 22, characterized in that the cut-out thin strips are covered with vitreous carbon.
